(19) United States
(12) Patent Application Publication
(10) Pub. No.: US 2014/0187466 A1
(43) Pub. Date: Jul. 3, 2014

(54) LAUNDRY DETERGENTS AND METHODS FOR MAKING LAUNDRY DETERGENTS CONTAINING METHYL ESTER ETHOXYLATES

(71) Applicant: THE DIAL CORPORATION, Scottsdale, AZ (US)

(72) Inventors: Bin Lin, Scottsdale, AZ (US); Pamela Lam, Scottsdale, AZ (US); Martina Spinatsch Kaiser, Phoenix, AZ (US)

(73) Assignee: THE DIAL CORPORATION, Scottsdale, AZ (US)

(21) Appl. No.: 14/138,184

(22) Filed: Dec. 23, 2013

Related U.S. Application Data
(60) Provisional application No. 61/747,182, filed on Dec. 28, 2012.

(51) Int. Cl. C11D 1/83

(52) U.S. Cl. CPC C11D 1/83
USPC 510/340; 510/276

(57) ABSTRACT

Laundry detergents, aqueous liquid laundry detergents, and methods for making laundry detergents are provided herein. In one embodiment, a laundry detergent includes an anionic surfactant and a nonionic surfactant including a methyl ester ethoxylate stable in an alkaline environment.

### TECHNICAL FIELD

The technical field relates generally to laundry detergents and methods for making laundry detergents, and more particularly relates to laundry detergents containing methyl ester ethoxylates (MEEs) as a nonionic surfactant component and methods for making such laundry detergents.

### BACKGROUND

Surfactants are typically used in laundry detergents to aid in washing fabrics. A surfactant is a compound that lowers the surface tension of a liquid or the interfacial tension between two liquids or between a liquid and a solid. When added to water for laundering, a surfactant significantly reduces the surface tension of the water, allowing the water to penetrate the fabric rather than slide off its surface. The result is that the water can function more effectively, acting to loosen the dirt from the clothing, and then hold it until it can be washed away.

Surfactants have a hydrophobic end and a hydrophilic end. The hydrophobic end consists of an uncharged carbohydrate group that can be straight, branched, cyclic or aromatic. Depending on the nature of the hydrophilic part the surfactants are classified as anionic, nonionic, cationic or amphoteric. Anionic surfactants have a hydrophilic end that consists of a negatively charged group like a sulfonate, sulfate or carboxylate. Conventional soaps are anionic surfactants. Over the last 50 years many soaps have been replaced with more efficient substances like alkyl sulfates, alkyl sulfonates and alkyl benzene sulfonates. Anionic surfactants are sensitive to water hardness. Nonionic surfactants include a non-charged hydrophilic part, e.g. an ethoxylate. Nonionic surfactants are not sensitive to water hardness. Cationic surfactants have a hydrophilic end that contains a positively-charged ion. Amphoteric surfactants or Zwitterionic surfactants have both cationic and anionic centers attached to the same molecule. Detergents using a combination of anionic and nonionic surfactants perform well in a variety of typical laundering conditions and are popular.

Alcohol ethoxylates (AEs) are the most common type of nonionic surfactant used in laundry detergents. The typical alcohol ethoxylate production process involves the transesterfication and fat splitting of refined, bleached, and deodorized oil, followed by hydrogenation to form C8-C18 fatty alcohols. The fatty alcohols are then ethoxylated by catalyzing a reaction with ethylene oxide to final alcohol ethoxylates. While alcohol ethoxylates perform well in laundry detergents, their production cost can be a concern. Therefore, a laundry detergent including a nonionic surfactant with similar or better performance than an alcohol ethoxylate at a lower cost is desirable.

Accordingly, it is desirable to provide laundry detergents that exhibit sufficient cleaning performance without the use of alcohol ethoxylates. Further, it is desirable to provide laundry detergents that use methyl ester ethoxylates (MEEs) as the nonionic component. In addition, it is desirable to provide methods for making such laundry detergents. Furthermore, other desirable features and characteristics will become apparent from the subsequent detailed description and the appended claims, taken in conjunction with the foregoing technical field and background.

### BRIEF SUMMARY

Laundry detergents, aqueous liquid laundry detergents, and methods for making laundry detergents are provided herein. In an exemplary embodiment, a laundry detergent includes an anionic surfactant and a nonionic surfactant including a methyl ester ethoxylate stable in an alkaline environment.

In accordance with another exemplary embodiment, an aqueous liquid laundry detergent is provided. The aqueous liquid laundry detergent includes at least about 60 wt % water. Further, the aqueous liquid laundry detergent includes at least about 5 wt % anionic surfactant. Also, the aqueous liquid laundry detergent includes at least about 1 wt % nonionic surfactant stable in an alkaline environment. The nonionic surfactant is methyl ester ethoxylate.

In accordance with another exemplary embodiment, a method for making a laundry detergent is provided. The method for making a laundry detergent includes forming an aqueous nonionic premix by mixing a nonionic surfactant, including a methyl ester ethoxylate stable in an alkaline environment, and water. Further, the method includes forming an aqueous anionic premix by mixing an anionic surfactant and water. Also, the method includes mixing the aqueous nonionic premix and the aqueous anionic premix with water until homogenous.

### DETAILED DESCRIPTION

The following detailed description is merely exemplary in nature and is not intended to limit the laundry detergents, liquid laundry detergents, or methods for making detergents described herein. Furthermore, there is no intention to be bound by any expressed or implied theory presented in the preceding technical field, background or brief summary, or in the following detailed description.

The various embodiments contemplated herein relate to laundry detergents, and particularly to aqueous liquid laundry detergents. Exemplary laundry detergents and exemplary aqueous liquid laundry detergents include a nonionic surfactant component that includes a methyl ester ethoxylate (MEE) that is stable in an alkaline environment. As used herein, “stable” means substantially no visual appearance change, substantially no performance degradation, and minor pH and viscosity change (less than 10%) after one week at 60° C. (140° F.).

### Nonionic Surfactant Component

The exemplary laundry detergent contains a nonionic surfactant comprising a methyl ester ethoxylate. In an exemplary embodiment, the methyl ester ethoxylate has an alkyl chain length of from about 10 to about 20 carbon atoms, such as from about 12 to about 16 carbon atoms. Further, an exemplary methyl ester ethoxylate has a degree of ethoxylation of from about 4 to about 18 ethylene oxide moieties, such as from about 9 ethylene oxide moieties to about 12 ethylene oxide moieties. Specifically, in one embodiment, the nonionic surfactant component consists of a 9-mole methyl ester ethoxylate. Such a methyl ester ethoxylate may be produced, for example, from soybean oil. In another embodiment, the nonionic surfactant consists of a 12-mole methyl ester ethoxylate formed from soybean oil. Certain embodiments of the laundry detergent may include both the 9-mole methyl ester ethoxylate and the 12-mole methyl ester ethoxylate. Each of these methyl ester ethoxylates are readily biodegradable and have a more favorable ecotoxicity profile than alcohol ethoxylates in general. Such methyl ester ethoxylates are commercially available under the trade name Surfonic® ME550-SO from the Huntsman Corp. of Salt Lake City, Utah.

Methyl ester ethoxylates are formed by the transesterification of refined, bleached, deodorized oil to form fatty methyl esters, followed by an ethoxylation process. Specifically, a catalyzed reaction between the fatty methyl esters and ethylene oxide forms the methyl ester ethoxylates. By using this production process to form methyl ester ethoxylates for use as the nonionic surfactant, the step of hydrogenation, required for alcohol ethoxylate production, is eliminated, thus reducing production costs for detergents.

Methyl ester ethoxylates may be produced from a wide variety of biological oil feedstocks including, without limitation, coconut oil, palm kernel oil (PKO), palm oil, soybean oil, corn oil, canola oil, tallow, and algae. These oil sources typically include triglycerides made of saturated fatty acids having from about six carbon atoms to about 18 carbon atoms. Generally, oils with long chain fatty acids, i.e., chain lengths greater than 12, are more economical than lauric-rich (C12) oils or oils with shorter chain fatty acids.

Unlike alcohol ethoxylates, methyl ester ethoxylates have a terminal methyl group, which tends to reduce foam formation. Therefore, methyl ester ethoxylates can be used in high efficiency detergents and in other hard surface formulations where low foam is desirable. Also, because methyl ester ethoxylates form less foam during a wash cycle, they are well designed for use in “one rinse” detergents. Such formulations provide for removing all detergent from laundry in a single rinse cycle to reduce overall water usage for sustainability.

Because methyl ester ethoxylates do not have a terminal hydroxyl group, hydrogen bonding of the surfactants is reduced. Reduced hydrogen bonding can result in less gel phase formation. Therefore, methyl ester ethoxylates may be well suited to formulations requiring low gel phase formation, such as high active ultraconcentrated detergents, liquid pouches, and detergent sheets.

Methyl ester ethoxylates include ester links that are typically unstable in strong acidic or alkaline environments. For example, such ester links are typically easily hydrolyzed in a highly alkaline environment, causing the surfactant to lose functionality. Many laundry detergents form an alkaline solution during laundry washing, such as those having a pH of over 7, for example of between about 9 and about 12. The exemplary methyl ester ethoxylates used in combination with the other detergent components discussed below provide surprising stability at high pH levels. Specifically, the exemplary laundry detergents include methyl ester ethoxylates that are stable at a pH of at least about 7.8, for example of at least about 9, such as of at least about 10, or at least about 11. In an exemplary embodiment, the methyl ester ethoxylate is stable at a pH of between about 9 and 12.5.

An exemplary detergent includes from about 1 weight percent (wt %) to about 5 wt % nonionic surfactant, such as about 1.5 wt % nonionic surfactant or about 3 wt % nonionic surfactant.

### Anionic Surfactant Component

The exemplary laundry detergent also contains an anionic surfactant. Exemplary anionic surfactants useful in this composition are the alkyl ether sulfates also known as alcohol ether sulfates. Alcohol ether sulfates are the sulfuric monoesters of the straight chain or branched C7-C21 alcohols ethoxylated with from about 0.5 to about 8 mol of ethylene oxide, such as C12-C18 alcohols containing from 0.5 to 8 EO. An anionic surfactant for use in an embodiment described herein is C12-C18 alcohol ether sulfate with a degree of ethoxylation of from about 0.5 to about 8 ethylene oxide moieties.

Other anionic surfactants that can be used are alkyl sulfates, also known as alcohol sulfates. These surfactants have the general formula R—O—SO₃Na where R contains from about 11 to 18 carbon atoms. The surfactants may also be denoted as sulfuric monoesters of C11-C18 alcohols, examples being sodium decyl sulfate, sodium palmityl alkyl sulfate, sodium myristyl alkyl sulfate, sodium dodecyl sulfate, sodium tallow alkyl sulfate, sodium coconut alkyl sulfate, and mixtures of these surfactants, or of C10-C20 oxo alcohols, and those monoesters of secondary alcohols of this chain length. Also useful are the alk(en)yl sulfates of this chain length that contain a synthetic straight-chain alkyl radical prepared on a petrochemical basis, these sulfates possessing degradation properties similar to those of the corresponding compounds based on fatty-chemical raw materials. An exemplary detergent uses C12-C16-alkyl sulfates, C12-C15-alkyl sulfates, and/or C14-C15 alkyl sulfates. In addition, 2,3-alkyl sulfates, which may for example be obtained as commercial products from Shell Oil Company under the name DAN®, may be suitable anionic surfactants.

Besides the alkyl sulfates or the alkyl ether sulfates, an exemplary liquid laundry detergent composition may comprise further anionic surfactants.

Other anionic surfactants that are useful in this composition are the alkyl benzene sulfonates. Suitable alkyl benzene sulfonates include the sodium salts of straight or branched-chain alkyl benzene sulfonic acids. Alkyl benzene sulfonic acids useful as precursors for these surfactants include decyl benzene sulfonic acid, undecyl benzene sulfonic acid, dodecyl benzene sulfonic acid, tridecyl benzene sulfonic acid, tetrapropylene benzene sulfonic acid and mixtures thereof. Exemplary sulfonic acids functioning as precursors to the alkyl benzene sulfonates useful for compositions herein are those in which the alkyl chain is linear and averages about 8 to 16 carbon atoms (C8-C16) in length. Examples of commercially available alkyl benzene sulfonic acids useful in the exemplary detergent include Calsoft LAS-99 marketed by the Pilot Chemical Company.

Further useful anionic surfactants include additional sulfonate type and sulfate type surfactants. Examples of useful sulfonate type surfactants are olefinsulfonates, i.e., mixtures of alkenesulfonates and hydroxyalkanesulfonates, and also disulfonates as are obtained, for example, from C12-C18-monoolefins having a terminal or internal double bond by sulfonating with gaseous sulfur trioxide followed by alkaline or acidic hydrolysis of the sulfonation products. Also suitable are alkanesulfonates, which are obtained from C12-C18-alkanes, for example by sulfochlorination or sulfoxidation with subsequent hydrolysis or neutralization, respectively. Likewise suitable, in addition, are the esters of .alpha.-sulfo fatty acids (ester sulfonates), e.g. the .alpha.-sulfonated methyl esters of hydrogenated coconut, palm kernel or tallow fatty acids.

Further suitable anionic surfactants are sulfated fatty acid glycerol esters that are the monoesters, diesters and triesters, and mixtures thereof, as obtained in the preparation by esterification of a monoglycerol with from 1 to 3 mol of fatty acid or in the transesterification of triglycerides with from 0.3 to 2 mol of glycerol. Exemplary sulfated fatty acid glyceryl esters are sulfation products of saturated fatty acids of 6 to 22 carbon atoms, e.g., of capric acid, caprylic acid, capric acid, myristic acid, lauric acid, palmitic acid, stearic acid or behenic acid.

Exemplary anionic surfactants also include the salts of alkylsulfosuccinic acid, which are also referred to as sulfosuccinates or as sulfosuccinic esters and which constitute the monoesters and/or diesters of sulfosuccinic acid with alcohols, for example fatty alcohols and ethoxylated fatty alcohols. Exemplary sulfosuccinates comprise C8-C18 fatty alcohol radicals or mixtures thereof. Exemplary sulfosuccinates contain a fatty alcohol radical derived from ethoxylated fatty alcohols, which themselves represent nonionic surfactants. Of use in an embodiment are the sulfosuccinates whose fatty alcohol radicals are derived from ethoxylated fatty alcohols having a narrowed homolog distribution. Similarly, it is also possible to use alk(en)ylsuccinic acid containing 8 to 18 carbon atoms in the alk(en)yl chain, or salts thereof.

Further suitable anionic surfactants are conventional soaps. Suitable soaps include saturated fatty acid soaps, such as the salts of lauric acid, myristic acid, palmitic acid, stearic acid, hydrogenated erucic acid and behenic acid, and mixtures of soaps derived from natural fatty acids, e.g., coconut, palm kernel, or tallow fatty acids. The anionic surfactants, including the soaps, may be present in the form of their sodium, potassium or ammonium salts and also as soluble salts of organic bases, such as mono-, di- or triethanolamine.

A further class of anionic surfactants is the class of ether carboxylic acids that are obtainable by reacting fatty alcohol ethoxylates with sodium chloroacetate in the presence of basic catalysts. Ether carboxylic acids have the general formula: R¹⁰O—(CH₂—CH₂—O)ₚ—CH₂—COOH where R¹⁰ contains C₁-C₁₈ and p is 0.1 to 20. Ether carboxylic acids are water hardness insensitive and have excellent surfactant properties. Softeners, Builders, Silicones, Solvents, Preservatives, Enzymes and Other Ingredients

In addition to surfactants, the laundry detergent contemplated herein may contain various additional components such as a softener, an antiredeposition agent, a corrosion inhibitor, a fluorescent whitening agent, a processing aid, a colorant, a fragrances, an opacifier, an oxygen bleach, an enzyme, a fabric softening agent, a chlorine scavenger, a dye transfer inhibitor, a malodor control agent, and a suds control agent.

Examples of fabric-softening components useful in the exemplary detergents are quaternary ammonium compounds. Other suitable fabric softening compositions are cationic polymers that include the polyquatemium polymers, as in the CTFA Cosmetic Ingredient Dictionary (The Cosmetic, Toiletry and Fragrance, Inc. 1997), in particular the polyquaternium-6, polyquaternium-7, and polyquaternium-10 polymers, also referred to as merquats, polyquatemium-4 copolymers, such as graft copolymers with a cellulose backbone and quaternary ammonium groups that are bonded via allyldimethylammonium chloride, cationic cellulose derivatives, such as cationic guar, such as guar hydroxypropyltriammonium chloride, and similar quaternized guar derivatives, cationic quaternary sugar derivatives (cationic alkyl polyglueosides), copolymers of PVP and dimethylaminomethacrylate, copolymers of vinylimidazole and vinylpyrrolidone, and aminosilicone polymers and copolymers. It is likewise possible to use polyquaternized polymers and also cationic biopolymers based on chitin and derivatives thereof. Likewise suitable are cationic silicone oils.

The compositions described herein may additionally comprise builders. Any builder customarily used in washing and cleaning compositions can be incorporated in the compositions described herein, including zeolites, silicates, carbonates, organic co-builders and phosphates. Some of these ingredients are known to provide the dual role of builder and chelant.

Useful silicates have the general formula NaMSiₓO₂ₓ₊₁H₂O, where M is sodium or hydrogen, x is from 1.9 to 4, y is from 0 to 20 and x is 2, 3 or 4. Exemplary crystalline sheet silicates of the stated formula are those in which M is sodium and x is 2 or 3. For example, beta.- and/or .delta.-sodium disilicates Na₂Si₂O₅.yH₂O may be included.

It is also possible to use amorphous sodium silicates having a Na₂O:SiO₂ modulus of from 1:2 to 1:3.3, such as from 1:2 to 1:2.8 and in particular from 1:2 to 1:2.6, which are dissolution-delayed and have secondary washing properties. The dissolution delay relative to conventional amorphous sodium silicates may have been brought about in a variety of ways, for example by surface treatment, compounding, compacting or by over-drying. As used herein, the term “amorphous” is understood as including “X-ray-amorphous”. This means that, in X-ray diffraction experiments, the silicates do not yield the sharp X-ray reflections typical of crystalline substances but instead yield at best one or more maxima of the scattered X-radiation, having a width of several degree units of the diffraction angle. However, even particularly good builder properties may result if the silicate particles in electron diffraction experiments yield vague or even sharp diffraction maxima. This is to be interpreted such that the products have microcrystalline regions with a size of from 10 to several hundred nm, for example, values up to a maximum of 50 nm such as up to a maximum of 20 nm. Such so-called X-ray amorphous silicates likewise have delayed dissolution compared with conventional water glasses. An exemplary embodiment includes compacted amorphous silicates, compounded amorphous silicates and/or over-dried X-ray amorphous silicates.

Zeolites used herein include zeolites A and/or P. Zeolite P may be Zeolite MAP® (commercial product from Crosfield). Also suitable, however, are zeolite X, and mixtures of A, X and/or P. A co-crystallizate of zeolite X and zeolite A (about 80% by weight of zeolite X), which is sold by CONDEA Augusta S.p.A. under the trade name VEGOBOND AX® and can be described by the formula nNa₂O.(1-n)K₂O.Al₂O₃(2-2,5)SiO₂(3,5-5,5) H₂O n=0.90-1.0 is, for example, also commercially available and is used in an exemplary embodiment. Useful zeolites have an average particle size of less than 10 μm (volume distribution; method of measurement: Coulter Counter) and have a bound-water content in the range from 18% to 22% by weight, such as in the range from 20% to 22% by weight. The zeolites can also be used as over-dried zeolites having lower water contents and then are by virtue of their hygroscopicity useful to remove unwanted trace residues of free water.

Phosphates can likewise be used as builders. Useful phosphates include the sodium and potassium salts of orthophosphates, pyrophosphates and tripolyphosphates.

Organic builder substances useful as cobuilders and obviously also as viscosity regulators include for example the polycarboxylic acids which can be used in the form of their sodium salts, polycarboxylic acids referring to carboxylic acids having more than one acid function. Examples thereof are citric acid, adipic acid, succinic acid, glutaric acid, malic acid, tartaric acid, maleic acid, fumaric acid, sugar acids, amino carboxylic acids, nitrilotriacetic acid (NTA) and derivatives thereof and also mixtures of these. Exemplary salts are the salts of polycarboxylic acids such as citric acid, adipic acid, succinic acid, glutaric acid, tartaric acid, sugar acids and mixtures of these.

Acids may also find use in the detergents described herein. As well as their builder action, the acids typically also have the property of an acidifying component and thus also serve to impart a lower and milder pH to washing or cleaning compositions. Particularly used for this are citric acid, succinic acid, glutaric acid, adipic acid, gluconic acid and any desired mixtures of these. Useful acidifying agents further include known pH regulators such as sodium bicarbonate and sodium hydrogensulfate.

Useful builders further include polymeric polycarboxylates, i.e., for example the alkali metal salts of polyacrylic acid or of polymethacrylic acid, for example those having a relative molecular mass in the range from 500 to 70,000 g/mol.

The molar masses reported herein for polymeric polycarboxylates are weight average molar masses M_{w} of the respective acid form, determined in principle by means of gel permeation chromatography (GPC) using a UV detector. The measurement was made against an external polyacrylic acid standard which, owing to its structural similarity to the polymers under investigation, provides realistic molecular weight values. These figures differ considerably from the molecular weight values obtained using polystyrenesulfonic acids as a standard. The molar masses measured against polystyrenesulfonic acids are generally distinctly higher than the molar masses reported herein.

Useful polymers are polyacrylates having a molecular mass in the range from 2000 to 20,000 g/mol. Owing to their superior solubility, the short-chain polyacrylates which have molar masses in the range from 2000 to 10,000 g/mol, such as in the range from 3000 to 5000 g/mol, are used in exemplary embodiments.

Useful polymers may further include substances that partly or wholly consist of units of vinyl alcohol or its derivatives.

Useful polymeric polycarboxylates further include copolymeric polycarboxylates, for example those of acrylic acid with methacrylic acid and of acrylic acid or methacrylic acid with maleic acid. Useful are copolymers of acrylic acid with maleic acid that comprise from 50% to 90% by weight of acrylic acid and from 50% to 10% by weight of maleic acid. Their relative molecular mass based on free acids is generally in the range from 2000 to 70,000 g/mol, such as in the range from 20,000 to 50,000 g/mol, for example in the range from 30,000 to 40,000 g/mol. Co-polymeric polycarboxylates can be used either as an aqueous solution or as a powder.

To improve solubility in water, polymers may further comprise allylsulfonic acids, such as allyloxybenzenesulfonic acid and methallylsulfonic acid, as a monomer.

Biodegradable polymers composed of more than two different monomer units, for example those that comprise salts of acrylic acid and of maleic acid and also vinyl alcohol or vinyl alcohol derivatives as monomers or comprise salts of acrylic acid and of 2-alkylallylsulfonic acid and also sugar derivatives as monomers may find use in embodiments described herein.

Exemplary co-polymers further include those that comprise acrolein and acrylic acid/acrylic acid salts or acrolein and vinyl acetate as monomers.

Additional builder substances further include polymeric amino dicarboxylic acids, their salts or their precursor substances. Exemplary builder substances are polyaspartic acids or salts and derivatives thereof, which have a bleach-stabilizing effect as well as cobuilder properties. It is further possible to use polyvinylpyrrolidones, polyamine derivatives such as quaternized and/or ethoxylated hexamethylenediamines.

Useful builder substances further include polyacetals that can be obtained by reacting dialdehydes with polycarboxylic acids having 5 to 7 carbon atoms and 3 or more hydroxyl groups. Exemplary polyacetals are obtained from dialdehydes such as glyoxal, glutaraldehyde, terephthalaldehyde and mixtures thereof and from polycarboxylic acids such as gluconic acid and/or glucoheptonic acid.

The compositions described herein may comprise builders in amounts of from 1% to 30% by weight of the total weight of the laundry detergent.

Furthermore, an exemplary laundry detergent composition may additionally comprise enzymes. Enzymes augment wash processes in various ways, especially in relation to the removal of difficult-to-bleach soils, such as protein stains.

Useful enzymes include in particular those from the class of the hydrolases such as the proteases, esterases, lipases or lipolytically acting enzymes, amylases, cellulases or other glycosyl hydrolases, hemicellulases, cutinases, P-glucanases, oxidases, peroxidases, perhydrolases or laccases and mixtures thereof. All these hydrolases contribute in the wash to the removal of stains such as proteinaceous, greasy or starchy stains and grayness. Cellulases and other glycosyl hydrolases may in addition, through the removal of pilling and microfibrils, contribute to textile color preservation and softness enhancement. Similarly, oxyreductases can be used for bleaching or for inhibiting dye transfer. Enzymatic actives obtained from bacterial strains or fungi such as Bacillus subtilis, Bacillus licheniformis, Streptomyceus griseus and Humicola insolens are particularly useful. Exemplary proteases are of the subtilisin type such as proteases obtained from Bacillus lentus. Of particular interest are enzyme mixtures, for example of protease and amylase or of protease and lipase or lipolytically acting enzymes or of protease and cellulase or of cellulase and lipase or lipolytically acting enzymes or of protease, amylase and lipase or of lipolytically acting enzymes or protease, lipase or lipolytically acting enzymes and cellulase, but especially protease and/or lipase-containing mixtures or mixtures with lipolytically acting enzymes. The familiar cutinases are examples of such lipolytically acting enzymes. Similarly, peroxidases or oxidases will be found useful in some cases. Useful amylases include especially α-amylases, isoamylases, pullulanases and pectinases. Exemplary cellulases used are cellobiohydrolases, endoglucanases and β-glucosidases, also known as cellobiases, and mixtures thereof. Since the various cellulase types differ in CMCase and Avicelase activity, desired activities can be achieved through specific mixtures of the cellulases.

The amount of enzyme(s), liquid enzyme preparation(s) or enzyme granule(s) may range from 0.01% to 5% by weight, such as from 0.12% to 2.5% by weight, each percentage being based on the entire laundry detergent.

In addition to water, the liquid laundry detergent composition described herein may comprise one or more other solvents. Solvents useful in the detergent compositions belong for example to the group of mono- or polyhydric alcohols, alkanolamines or glycol ethers provided they are miscible with water in the stated concentration range. Exemplary solvents may comprise ethanol, n-propanol, i-propanol, butanols, glycol, propanediol, butanediol, glycerol, diglycol, propyldiglycol, butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, butoxypropoxypropanol (BPP), dipropylene glycol monomethyl ether, dipropylene glycol monoethyl ether, diisopropylene glycol monomethyl ether, diosopropylene glycol monoethyl ether, methoxytriglycol, ethoxytriglycol, butoxytriglycol, 1-butoxy-ethoxy-2-propanol, 3-methyl-3-methoxybutanol, propylene glycol t-butyl ether and also mixtures thereof.

Some glycol ethers are available under the trade names Arcosolv® (Arco Chemical Co.) or Cellosolv®, Carbitol® or Propasol® (Union Carbide Corp.); these also include for example ButylCarbitol®, HexylCarbitol®, MethylCarbitol® and Carbitol® itself, (2-(2-ethoxy)ethoxy)ethanol. The choice of glycol ether can be readily made by one skilled in the art on the basis of its volatility, water-solubility, weight percentage of the total composition and the like. Pyrrolidone solvents, such as N-alkylpyrrolidones, for example N-methyl-2-pyrrolidone or N—C₈—C₁₂-alkylpyrrolidone, or 2-pyrrolidone, can likewise be used.

Alcohols that can be employed as co-solvents in an exemplary detergent include liquid polyethylene glycols having a comparatively low molecular weight, for example polyethylene glycols having a molecular weight of 200, 300, 400 or 600. Useful co-solvents further include other alcohols, for example (a) lower alcohols such as ethanol, propanol, isopropanol and n-butanol, (b) ketones such as acetone and methyl ethyl ketone, (c) C2-C4-polyols such as a diol or a triol, for example ethylene glycol, propylene glycol, glycerol or mixtures thereof. 1,2-octanediol is an exemplary diol.

The compositions described herein may comprise one or more water-soluble organic solvents in an exemplary embodiment. Water-soluble is here to be understood as meaning that an organic solvent referred to is soluble in an aqueous composition in the amount in which it is included therein.

Furthermore, an exemplary laundry detergent composition may further comprise thickeners. The use of thickeners in particular in gel-like liquid laundry detergent compositions will boost consumer acceptance. The thickened consistency of the composition simplifies the application of the compositiondirectly to the stains to be treated.

Polymers originating in nature that are used as thickeners are, for example, agar-agar, carrageen, tragacanth, gum arabic, alginates, pectins, polyoses, guar flour, carob seed flour, starch, dextrins, gelatins and casein.

Modified natural substances originate primarily from the group of modified starches and celluloses, examples of which may be mentioned here being carboxymethylcellulose and cellulose ethers, hydroxyethylcellulose and hydroxypropylcellulose, and carob flour ether.

A large group of thickeners that are used widely in very diverse fields of application includes the completely synthetic polymers, such as polyacrylic and polymethacrylic compounds, vinyl polymers, polycarboxylic acids, polyethers, polyimines, polyamides and polyurethanes.

Thickeners from such classes of substance are commercially widely available and are offered, for example, under the trade names Acusol®-820 (methacrylic acid (stearyl alcohol-20-EO) ester-acrylic acid copolymer, 30% strength in water, Rohm & Haas), Polygel®, such as Polygel DA (3V Sigma), Carbopol®(B.F. Goodrich), such as Carbopol 940 (molecular weight approximately 4,000,000), Carbopol 941 (molecular weight approximately. 1,250,000), Carbopol 934 (molecular weight approximately 3,000,000), Carbopol ETD 2623, Carbopol 1382 (INCI Acrylates/C10-30 Alkyl Acrylate Crosspolymer) and Carbopol Aqua 30, Aculyn® and Acusol® (Rohm & Haas), Tego® Degussa-Goldschmidt), Dapral®-GT-282-S (alkyl polyglycol ether, Akzo), Deuterole-Polymer-11 (dicarboxylic acid copolymer, Schoner GmbH), Deuteron®-XG (anionic heteropolysaccharide based on β-D-glucose, D-mannose, D-glucuronic acid, Schoner GmbH), Deuteron®-XN (nonionogenic polysaccharide, Schoner GmbH), Dicrylan®-Verdicker-O (ethylene oxide adduct, 50% strength in water/isopropanol, Pferse Chemie), EMA®-81 and EMA®-91 (ethylene-maleic anhydride copolymer, Monsanto), Verdicker-QR-1001 (polyurethane emulsion, 19-21% strength in water/diglycol ether, Rohm & Haas), Mirox®-AM (anionic acrylic acid-acrylic ester copolymer dispersion, 25% strength in water, Stockhausen), SER-AD-FX-1100 (hydrophobic urethane polymer, Servo Delden), Shellflo®-S (high molecular weight polysaccharide, stabilized with formaldehyde, Shell), and Shellflo®-XA (xanthan biopolymer, stabilized with formaldehyde, Shell).

An exemplary polymeric polysaccharide thickener is xanthan, a microbial anionic heteropolysaccharide produced by Xanthomonas campestris and other species under aerobic conditions and has a molar mass in the range from 2 to 15 million g/mol. Xanthan is formed from a chain of β-1,4-bound glucose (cellulose) having side chains. The structure of the subgroups consists of glucose, mannose, glucuronic acid, acetate and pyruvate, the number of pyruvate units determining the viscosity of the xanthan

In an exemplary embodiment, the liquid laundry detergent composition comprises thickeners in amounts up to 10% by weight, such as up to 5% by weight, for example in the range from 0.1% to 1% by weight, each based on the entire laundry detergent.

The laundry detergents described herein also may comprise bleaches. Among compounds that serve as bleaches in that they liberate H₂O₂ in water include sodium percarbonate, sodium perborate tetrahydrate and sodium perborate monohydrate. Useful bleaches further include for example peroxypyrophosphates, citrate perhydrates, and also H₂O₂-supplying peracidic salts or peracids, such as persulfates and persulfuric acid. It is also possible to use urea peroxohydrate, i.e., percarbamide, which is described by the formula H₂N—CO—NH₂.H₂O₂. Organic bleaches also can be used. Typical organic bleaches include diacyl peroxides, for example dibenzoyl peroxide. Typical organic bleaches further include peroxyacids, examples being in particular alkylperoxyacids and arylperoxy-acids. Exemplary representatives are peroxybenzoic acid and its ring-substituted derivatives, such as alkylperoxybenzoic acids, but also peroxy-α-naphthoic acid and magnesium monoperphthalate, aliphatic or substitutedly aliphatic peroxyacids, such as peroxylauric acid, peroxystearic acid, ε-phthalimidoperoxycaproic acid (phthalimidoperoxyhexanoic acid, PAP), o-carboxybenzamidoperoxycaproic acid, N-nonenylamidoperadipic acid and N-nonenylamidopersuccinates, and alipahtic and araliphatic peroxydicarboxylic acids, such as 1,12-diperoxy carboxylic acid, 1,9-diperoxyazelaic acid, diperoxysebacic acid, diperoxybrassylic acid, diperoxyphthalic acids, 2-decyldiperoxybutane-1,4-diacid, N,N-terephthaloyldi(6-aminopercaproic acid).

The compositions described herein may comprise bleach activators. Compounds used as bleach activators produce aliphatic peroxo carboxylic acids having 1 to 10 carbon atoms, such as 2 to 4 carbon atoms, and/or, as the case may be, substituted perbenzoic acid under perhydrolysis conditions. Substances that bear O— and/or N-acyl groups of the stated number of carbon atoms and/or substituted or unsubstituted benzoyl groups are suitable. Exemplary are multiple acylated alkylenediamines, such as tetraacetylethylenediamine (TAED), acylated triazine derivatives, especially 1,5-diacetyl-2,4-dioxohexahydro-1,3,5-tri-azine (DADHT), acylated glycolurils, tetra-acetylglycoluril (TAGU), N-acylimides, N-nonanoylsuccinimide (NOSI), acylated phenolsulfonates, especially n-nonanoyl- or isononanoyloxybenzenesulfonate (n- and iso-NOBS respectively), carboxylic anhydrides, phthalic anhydride, acylated polyhydric alcohols, triacetin, triethyl acetylcitrate (TEAC), ethylene glycol diacetate, 2,5-diacetoxy-2,5-dihydrofuran and the enol esters and also acetylated sorbitol and mannitol, acylated sugar derivatives, especially pentaacetylglucose (PAG), pentaacetylfructose, tetraacetylxylose and octaacetyllactose and also acylated, optionally N-alkylated glutamine and gluconolactone, and/or N-acylated lactams, for example N-benzoylcaprolactam. The hydrophilically substituted aceylacetals and the acyllactams are likewise useful. Similarly, the combinations of conventional bleach activators can likewise be used.

Furthermore, an exemplary laundry detergent composition may additionally comprise complexing agents. Complexing agents improve the stability of the compositions and protect for example against heavy metal catalyzed decomposition of certain ingredients of detersive formulations.

The group of complexing agents includes for example the alkali metal salts of nitrilotriacetic acid (NTA) and its derivatives and also alkali metal salts of anionic polyelectrolytes such as polyacrylates, polymaleates and polysulfonates and the various salts of ethylenediaminetetraacetic acid (EDTA). Of use in an embodiment herein is tetrasodium ethylenediaminetetracetate (Na₄-EDTA). Useful complexing agents further include low molecular weight hydroxy carboxylic acids such as citric acid, tartaric acid, malic acid or gluconic acid and their salts. These compounds include in particular organophosphonates such as for example 1-hydroxyethane-1,1-diphosphonic acid (HEDP), aminotri(methylenephosphonic acid) (ATMP), diethylenetriaminepenta-(methylenephosphonic acid) (DTPMP or DETPMP) and also 2-phosphonobutane-1,2,4-tricarboxylic acid (PBS-AM), which are usually used in the form of their ammonium or alkali metal salts.

In an exemplary embodiment of the liquid laundry detergent compositions the complexing agents are present in an amount up to 10% by weight, for example from 0.01% to 5% by weight, such as from 0.1% to 2% by weight or from 0.3% to 1.0% by weight, each percentage being based on the entire laundry detergent.

The compositions described herein may comprise electrolytes. A large number of various salts can be used as electrolytes from the group of the inorganic salts. Exemplary cations are the alkali and alkaline earth metals and exemplary anions are the halides and sulfates. From the point of view of manufacturing convenience, the use of NaCl or MgCl₂ in the compositions described herein may be preferred. The fraction of electrolytes in the compositions described herein is typically in the range from 0.5% to 5% by weight of the total laundry detergent.

The compositions described herein may comprise pH standardizers. To adjust the pH of the compositions into the desired range, the use of pH standardizers may be indicated. Useful pH standardizers include all known acids and alkalis unless their use is ruled out by performance or ecological concerns or by consumer protection concerns. Typically, the amount of these standardizers does not exceed 2% by weight of the total formulation.

The compositions described herein may comprise dyes and fragrances. Dyes and fragrances may be added to exemplary compositions in order to enhance the esthetic appeal of the detergent and to provide the consumer with not only the washing or cleaning performance but also a visually and sensorially “typical and unmistakable” product. As perfume oils and/or fragrances it is possible to use individual odorant compounds, examples being the synthetic products of the ester, ether, aldehyde, ketone, alcohol and hydrocarbon types. It is possible to use mixtures of different odorants, which together produce an appealing fragrance note. Such perfume oils may also contain natural odorant mixtures, as are obtainable from plant sources.

The compositions described herein may additionally comprise optical brighteners. Optical brighteners (so-called “whitening agents” or “fluorescent whiteners”) can be added to the detergent in order to eliminate graying and yellowing of the treated textiles. These substances attach to the fibers and bring about a brightening and simulated bleaching action by converting invisible ultraviolet radiation into visible longer-wave length light, the ultraviolet light absorbed from sunlight being irradiated as a pale bluish fluorescence and, together with the yellow shade of the grayed or yellowed laundry, producing pure white. Suitable compounds originate, for example, from the classes of substance of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazol, benzisoxazol and benzimidazol systems, and pyrene derivatives substituted by heterocycles. The optical brighteners are usually used in amounts between 0.005% and 0.3% by weight, based on the total laundry detergent.

The compositions described herein may comprise UV absorbers. The compositions may comprise UV absorbers which go onto the treated textiles and improve the light stability of the fibers and/or the light stability of the other formula components. UV absorbers should be understood to mean organic substances (light filters) which are capable of absorbing ultraviolet rays and reemitting the absorbed energy in the form of longer-wave radiation, e.g. heat. Examples of compounds that have these desired properties are the compounds active through non-radiative deactivation and derivatives of benzophenone with substituents in the 2- and/or 4-position. Further, substituted benzotriazoles, such as for example the water-soluble benzenesulfonic acid-3-(2H-benzotriazol-2-yl)-4-hydroxy-5-(methylpropyl)-monosodium salt (Cibafast® H), acrylates phenyl-substituted in the 3-position (cinnamic acid derivatives), optionally with cyano groups in the 2-position, salicylates, organic Ni complexes and natural substances such as umbelliferone and the endogenous urocanic acid are suitable. Of particular importance are biphenyl-derivatives and, above all, stilbene derivatives and are commercially available from Ciba as Tinosorb® FD or Tinosorb® FR. As UV-B absorbers, mention can be made of 3-benzylidenecamphor and 3-benzylidene-norcamphor and derivatives thereof, e.g. 3-(4-methylbenzylidene)camphor, 4-aminobenzoic acid derivatives, such as 4-(dimethylamino)benzoic acid 2-ethylhexyl ester, 4-(dimethylamino)benzoic acid 2-octyl ester and 4-(dimethylamino)benzoic acid amyl ester, esters of cinnamic acid, for example 4-methoxycinnamic acid 2-ethylhexyl ester, 4-methoxycinnamic acid propyl ester, 4-methoxycinnamic acid isoamyl ester and 2-cyano-3,3-phenylcinnamic acid 2-ethylhexyl ester (Octocrylene), esters of salicylic acid, such as salicylic acid 2-ethylhexyl ester, salicylic acid 4-isopropylbenzyl ester and salicylic acid homomenthyl ester, derivatives of benzophenone, such as 2-hydroxy-4-methoxybenzophenone, 2-hydroxy-4-methoxy-4′-methylbenzophenone and 2,2′-dihydroxy-4-methoxy-benzophenone, esters of benzalmalonic acid, for example 4-methoxybenzmalonic acid di-2-ethylhexyl ester, triazine derivatives such as for example 2,4,6-trianilino-(p-carbo-2′-ethyl-1′-hexyloxy)-1,3,5-triazine and octyl triazone, or dioctyl butamido triazone (Uvasorb® HEB), propane-1,3-diones such as for example 1-4-tert-butylphenyl)-3-(4′-methoxyphenyl)propane-1,3-dione and ketotricyclo-(5.2.1.0)decane derivatives. Also suitable are 2-phenylbenzimidazole-5-sulfonic acid and alkali metal, alkaline earth metal, ammonium, alkylammonium, alkanolammonium and glucammonium salts thereof, sulfonic acid derivatives of benzophenones, such as 2-hydroxy-4-methoxybenzophenone-5-sulfonic acid and salts thereof, sulfonic acid derivatives of 3-benzylidenecamphor, such as for example 4-(2-oxo-3-bomylidenemethyl)benzene-sulfonic acid and 2-methyl-5-(2-oxo-3-bomylidene)sulfonic acid and salts thereof.

Typical UV-A filters are in particular derivatives of benzoylmethane, such as for example 1-(4′-tert-butyl-phenyl)-3-(4′-methoxyphenyl)propane-1,3-dione, 4-tert-butyl-4′-methoxydibenzoylmethane (Parsol 1789), 1-phenyl-3 -(4′-isopropylphenyl)-propane-1,3-dione and also enamine compounds. The UV-A and UV-B filters can of course also be used as mixtures. In addition to the stated soluble substances, insoluble light-protective pigments, which are finely dispersed metal oxides or salts, such as nanoized metal oxides or salts, are also possible for this. Examples of suitable metal oxides are in particular zinc oxide and titanium dioxide and also oxides of iron, zirconium, silicon, manganese, aluminum and cerium and also mixtures thereof. As salts, silicates (talc), barium sulfate or zinc stearate can be used. The oxides and salts are already used in the form of the pigments for skincare and skin protection emulsions and decorative cosmetics. The particles here should have a mean diameter of less than 100 nm, such as between 5 and 50 nm and in particular between 15 and 30 nm. They can be spherical in shape, but particles having an ellipsoidal shape or a shape deviating in other ways from the spherical form can also be used. The pigments can also be surface-treated, i.e. hydrophobized or hydrophilized. Typical examples are coated titanium dioxides, such as for example titanium dioxide T 805 (Degussa) or Eusolex® T2000 (Merck). Possible hydrophobic coating agents here are above all silicones and specifically trialkoxyoctyl-silanes or simethicones. In an exemplary embodiment, micronized zinc oxide is used. UV absorbers are typically used in amounts ranging from 0.01% by weight to 5% by weight, such as from 0.03% by weight to 1% by weight, of the total laundry detergent.

The compositions described herein may comprise crease control agents. Since textile fabrics, especially those composed of rayon, wool, cotton and blends thereof, can tend to crease because the individual fibers are sensitive to bending, kinking, pressing and squashing transversely to the fiber direction, the compositions may comprise synthetic anticrease agents. These include for example synthetic products based on fatty acids, fatty acid esters, fatty acid amides, fatty acid alkylolesters, fatty acid alkylolamides or fatty alcohols, which have mostly been reacted with ethylene oxide, or products based on lecithin or modified phosphoric esters.

The compositions described herein may comprise grayness inhibitors. Grayness inhibitors are designed to keep the soil detached from the fiber suspended in the liquor and to prevent its redeposition on the fiber. Useful grayness inhibitors include water-soluble colloids mostly organic in nature, for example glue, gelatin, salts of ether sulfonic acids of starch or of cellulose or salts of acidic sulfuric esters of cellulose or of starch. Similarly, water-soluble polyamides which comprise acidic groups are suitable for this purpose. It is also possible to use soluble starch preparations and starch products other than those mentioned above, for example degraded starch, aldehyde starches, etc. Polyvinylpyrrolidone can be used as well. However, an exemplary embodiment utilizes cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose.

The liquid laundry detergent compositions described herein may further comprise dye transfer inhibitors. For example, the compositions described herein may comprise from 0.1% by weight to 2% by weight of the total laundry detergent, which may comprise a polymer of vinylpyrrolidone, vinylimidazole, vinylpyridine N-oxide or a copolymer of these. Useful dye transfer inhibitors include not only the polyvinylpyrrolidones of molecular weights in the range from 15 000 to 50,000 but also the polyvinylpyrrolidones having molar weights above 1,000,000, especially from 1,500,000 to 4,000,000, the N-vinylimidazole-N-vinylpyrrolidone copolymers, the polyvinyloxazolidones, the copolymers based on vinyl monomers and carboxamides, the polyesters and polyamides containing pyrrolidone groups, the grafted polyamidoamines and polyethyleneimines, the polymers with amide groups from secondary amines, the polyamine N-oxide polymers, the polyvinyl alcohols, and the copolymers based on acrylamidoalkenylsulfonic acids. However, it is also possible to use enzymatic systems, comprising a peroxidase and hydrogen peroxide or a substance, which in water provides hydrogen peroxide. The addition of a mediator compound for the peroxidase, for example, an acetosyringone, a phenol derivative, or a phenothiazine or phenoxazine, may be used in an exemplary embodiment though it is also possible to use abovementioned active polymeric dye transfer inhibitor substances as well. Polyvinylpyrrolidone for use in an exemplary detergent typically has an average molar mass in the range from 10,000 to 60,000, in particular in the range from 25,000 to 50,000. Exemplary copolymers are vinylpyrrolidone and vinylimidazole in a molar ratio of 5:1 to 1:1 having an average molar mass in the range from 5000 to 50,000, in particular from 10,000 to 20,000.

It may also be useful to include foam inhibitors into the liquid laundry compositions according to an embodiment. Suitable foam inhibitors that can be used in the laundry detergents are, for example, soaps, paraffins or silicone oils, which may optionally be applied to carrier materials. Suitable anti-redeposition agents, which are also referred to as soil repellants, are, for example, nonionic cellulose ethers, such as methylcellulose and methylhydroxypropylcellulose with a content of methoxy groups of from 15 to 30% by weight and of hydroxypropyl groups of from 1 to 15% by weight, in each case based on the nonionic cellulose ethers, and the polymers, known from the prior art, of phthalic acid and/or terephthalic acid or derivatives thereof, in particular polymers of ethylene terephthalates and/or polyethylene glycol terephthalates or anionically and/or nonionically modified derivatives of these. An exemplary embodiment uses the sulfonated derivatives of phthalic acid and terephthalic acid polymers.

To control microorganisms, an exemplary detergent can include antimicrobial active ingredients. Useful antimicrobial agents include but are not limited to benzalkonium chlorides, alkylarylsulfonates, halophenols, phenol mecuriacetate, methylchloroisothiazolinone and methylisothiazolinone.

As well as the aforementioned components, an exemplary laundry detergent composition may comprise pearl luster agents. Pearl luster agents endow textiles with an additional luster. Useful pearl luster agents include for example: alkylene glycol esters; fatty acid alkanolamides; partial glycerides; esters of polybasic carboxylic acids with or without hydroxyl substitution with fatty alcohols having 6 to 22 carbon atoms; fatty materials, for example fatty alcohols, fatty ketones, fatty aldehydes, fatty ethers and fatty carbonates, which together have at least 24 carbon atoms; ring-opening products of olefin epoxides having 12 to 22 carbon atoms with fatty alcohols having 12 to 22 carbon atoms, fatty acids and/or polyols having 2 to 15 carbon atoms and 2 to 10 hydroxyl groups and also mixtures thereof.

The inclusion of a silicone copolyol carboxylate helps softening by complexing with the cationic fabric-softening compound and providing silky & slick hand feeling. The complex also helps aid the solubility and delivery of the cationic fabric-softening compounds from solution to substrate. This product is available from Lambent Technologies under the trademark Lambent Syngard CPI.

While any type of detergent may be formulated with the components described herein, in an exemplary embodiment the detergent is an aqueous liquid laundry detergent. An exemplary aqueous liquid laundry detergent includes at least about 60 wt % water, at least about 5 wt % anionic surfactant, and at least about 1 wt % nonionic surfactant (methyl ester ethoxylate) stable in an alkaline environment. For example, an exemplary aqueous liquid laundry detergent includes from about 80 wt % to about 85 wt % water, from about 8 wt % to about 12 wt % anionic surfactant, and from about 1.4 wt % to about 3.2 wt % methyl ester ethoxylate. The exemplary aqueous liquid laundry detergent includes 0.0% alcohol ethoxylate.

### Method of Making Laundry Detergent

An exemplary method for making the laundry detergent includes forming an aqueous nonionic premix by mixing the nonionic surfactant methyl ester ethoxylate with water. Further, an aqueous anionic premix is formed by mixing an anionic surfactant and water. Then, the aqueous nonionic premix and the aqueous anionic premix are added to water in a batch process and agitated until homogenous. During agitation the other components are added to the batch. If a component is in solid form, it is first mixed with water to form a premix before being added to the batch.

### EXAMPLE 1

The following is an example of a laundry detergent for use in a high pH environment in accordance with an exemplary embodiment. The example is provided for illustration purposes only and is not meant to limit the various embodiments of the laundry detergent in any way. All materials are set forth in weight percent of the total weight of the laundry detergent.

### EXAMPLE 1

### High pH Formula with a pH of 11.2

| Ingredient | Wt % |
|---|---|
| Water | 75-85 |
| Fatty Acid | 0.02-0.2 |
| Sodium linear alkylbenzene sulfonate (NaLAS) | 2.5-5.0 |
| Sodium lauryl ether sulfate (SLES) | 4.0-8.0 |
| Methyl Ester Ethoxylates (MEE) | 0.8-3.0 |
| Sodium Carbonate | 2.2-5.0 |
| Polymer | 0.2-1.0 |
| Ethylenediaminetetraacetic acid (EDTA) | 0.0.2-0.2 |
| Isothiazolinone Preservative | 0.001-0.02 |
| NaCl | 0.8-3.0 |
| Fragrance | 0.2-0.8 |
| Fluorescent Whitening Agent | 0.01-0.2 |
| Dye | 0.001-0.01 |
| Total | 100.0 |

### EXAMPLE 2

The following is an example of a laundry detergent designed for sustainability or as a “green formula” in accordance with an exemplary embodiment. The example is provided for illustration purposes only and is not meant to limit the various embodiments of the laundry detergent in any way. All materials are set forth in weight percent of the total weight of the laundry detergent.

### EXAMPLE 2

### Green Formula with a pH of 8

| Ingredient | Wt % |
|---|---|
| Water | 75-85 |
| Fatty Acid | 0.15-0.5 |
| SLES | 5.0-10.0 |
| MEE | 0.8-3.0 |
| Sodium Bicarbonate | 0.2-1.2 |
| Polymer | 0.1-0.5 |
| Isothiazolinone Preservative | 0.005-0.02 |
| NaCl | 3.0-5.0 |
| Fragrance | 0.2-0.5 |
| Fluorescent Whitening Agent | 0.005-0.02 |
| Total | 100.0 |

### EXAMPLE 3

The following is an example of a laundry detergent including enzymatic cleaning in accordance with an exemplary embodiment. The example is provided for illustration purposes only and is not meant to limit the various embodiments of the laundry detergent in any way. All materials are set forth in weight percent of the total weight of the laundry detergent.

### EXAMPLE 3

### Enzymatic Formula with a pH of 7.8

| Ingredient | Wt % |
|---|---|
| Water | 75-85 |
| Fatty Acid | 0.02-0.2 |
| SLES | 5.0-12.0 |
| MEE | 1.0-6.0 |
| Sodium Bicarbonate | 0.1-0.5 |
| Polymer | 0.1-1.0 |
| Sodium Formate | 0.5-2.0 |
| Isothiazolinone Preservative | 0.002-0.02 |
| NaCl | 2.0-5.0 |
| Fragrance | 0.15-0.5 |
| Fluorescent Whitening Agent | 0.03-0.12 |
| Calcium Chloride | 0.04-1.8 |
| Protease | 0.03-1.6 |
| Mannanase | 0.05-0.25 |
| Amylase | 0.05-0.25 |
| Total | 100.0 |

Accordingly, laundry detergents, such as aqueous liquid laundry detergents have been disclosed. The detergents include, as their nonionic surfactant component, methyl ester ethoxylates. Unlike the prior art, the exemplary embodiments taught herein are stable in alkaline environments, and even in highly alkaline environments.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the processes without departing from the scope defined by the claims, which includes known equivalents and foreseeable equivalents at the time of filing this patent application.

What is claimed is:

1. A laundry detergent comprising:
an anionic surfactant; and
a nonionic surfactant including a methyl ester ethoxylate stable in an alkaline environment.

2. The laundry detergent of claim 1 wherein the methyl ester ethoxylate has an alkyl chain length of from about 6 to about 20 carbon atoms.

3. The laundry detergent of claim 1 wherein the methyl ester ethoxylate has an alkyl chain length of from about 12 to about 16 carbon atoms.

4. The laundry detergent of claim 1 wherein the methyl ester ethoxylate has a degree of ethoxylation of about 4 to about 18 ethylene oxide moieties.

5. The laundry detergent of claim 1 wherein the methyl ester ethoxylate has a degree of ethoxylation of about 9 ethylene oxide moieties.

6. The laundry detergent of claim 1 wherein the methyl ester ethoxylate has a degree of ethoxylation of about 12 ethylene oxide moieties.

7. The laundry detergent of claim 1 wherein the detergent comprises from about 1 wt% to about 5 wt % nonionic surfactant.

8. The laundry detergent of claim 1 wherein the detergent comprises about 1.5 wt% nonionic surfactant.

9. The laundry detergent of claim 1 wherein the detergent comprises about 3 wt % nonionic surfactant.

10. The laundry detergent of claim 1 wherein the methyl ester ethoxylate is stable at a pH of at least about 7.8.

11. The laundry detergent of claim 1 wherein the methyl ester ethoxylate is stable at a pH of at least about 9.

12. The laundry detergent of claim 1 wherein the methyl ester ethoxylate is stable at a pH of at least about 10.

13. The laundry detergent of claim 1 wherein the methyl ester ethoxylate is stable at a pH of between about 9 and 12.5.

14. The laundry detergent of claim 1 further comprising at least one enzyme.

15. An aqueous liquid laundry detergent comprising
at least about 60 wt % water;
at least about 5 wt % anionic surfactant; and
at least about 1 wt % nonionic surfactant stable in an alkaline environment, wherein the nonionic surfactant is methyl ester ethoxylate.

16. The aqueous liquid laundry detergent of claim 15 comprising
from about 80 wt % to about 85 wt % water;
from about 8 wt % to about 12 wt % anionic surfactant; and
from about 1.4 wt % to about 3.2 wt % methyl ester ethoxylate.

17. The aqueous liquid laundry detergent of claim 15 wherein the methyl ester ethoxylate is stable at a pH of between about 9 and 12.5.

18. The aqueous liquid laundry detergent of claim 15 wherein the methyl ester ethoxylate has an alkyl chain length of from about 12 to about 16 carbon atoms and has a degree of ethoxylation of about 9 to about 12 ethylene oxide moieties.

19. The aqueous liquid laundry detergent of claim 15 wherein the aqueous liquid laundry detergent comprises 0.0% alcohol ethoxylate.

20. A method for making a laundry detergent comprising:
forming an aqueous nonionic premix by mixing a nonionic surfactant, including a methyl ester ethoxylate stable in an alkaline environment, and water;
forming an aqueous anionic premix by mixing an anionic surfactant and water; and
mixing the aqueous nonionic premix and the aqueous anionic premix with water until homogenous.
